(19) United States
(12) Patent Application Publication
(10) Pub. No.: US 2022/0176180 A1
(43) Pub. Date: Jun. 9, 2022

(54) SOLENOID-ACTUATED FIRE SPRINKLER SYSTEM

(71) Applicant: Ricky Jay Kramer, Aurora, CO (US)

(72) Inventor: Ricky Jay Kramer, Aurora, CO (US)

(21) Appl. No.: 17/304,410

(22) Filed: Jun. 21, 2021

Related U.S. Application Data
(60) Provisional application No. 63/122,303, filed on Dec. 7, 2020.

(51) Int. Cl. A62C 37/44

(52) U.S. Cl. CPC A62C 37/44

(57) ABSTRACT

An apparatus, system, and method for providing an improved fire sprinkler is disclosed. A solenoid valve is provided that couples to a pipe system of the fire sprinkler system. The solenoid valve is operably associated with at least one of a heat detector such that the solenoid valve opens and water is permitted to flow through the solenoid valve and pipe system when a signal is received from the at least one of a heat detector and a smoke detector. The system may be activated by 24 volts direct current, which increases system reliability and dependability.

### CROSS-REFERENCE TO RELATED APPLICATION

This application claims the benefit of priority of U.S. provisional application No. 63/122,303, filed Dec. 7, 2020, the contents of which are herein incorporated by reference.

### BACKGROUND OF THE INVENTION

The present invention relates to fire sprinklers and, more particularly, to a fire sprinkler dry valve design that utilizes solenoid technology.

Occasionally dry or reaction fire sprinkler systems accidentally trip, causing water damage or freeze ups in cold weather. When they accidentally trip, that also typically results in an unnecessary response by the fire department. Existing systems rely on too many moving components that can eventually fail and cause false fire alarms. Additionally, antifreeze systems require extensive maintenance, which tend to be costly.

As can be seen, there is a need for a system that will not accidentally trip and that does not require an actuator, accelerator or additional sensing components that eventually fail. Rather, there is a need for a system that includes a solenoid activated electronically during a fire event, as detailed in the following disclosure and defined in the claims below.

### SUMMARY OF THE INVENTION

In one aspect of the present invention, a fire sprinkler system includes: a pipe system; at least one of a heat and or smoke detector; and a solenoid valve coupled along the pipe system and operably associated with at least one of a heat detector and the smoke detector. the solenoid valve being operable to permit water to flow there through upon receiving a signal from the at least one of a heat detector and a smoke detector.

In another aspect of the present invention, an apparatus configured for use with a fire sprinkler system includes: a solenoid valve being configured: to couple along a pipe system of the fire sprinkler system; and to be operably associated with at least one of a heat detector and a smoke detector, the solenoid valve being operable to permit water to flow therethrough upon receiving a signal from the at least one of a heat detector and a smoke detector.

In yet another aspect of the present invention, a method includes the steps of: (1) providing a fire sprinkler system including: a pipe system; at least one of a heat detector and a smoke detector; and a solenoid valve coupled along the pipe system and operably associated with the at least one of a heat detector and the smoke detector; (2) receiving a signal from the at least one of a heat detector and a smoke detector; and (2) operating the solenoid valve to permit water to flow therethrough.

These and other features, aspects and advantages of the present invention will become better understood with reference to the following drawings, description and claims.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a perspective view of an embodiment of the present invention;

FIG. 2 is a flow chart of the operation of the embodiment of the present invention; and

FIG. 3 is a schematic view of the operation of the embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention include apparatuses, systems, and methods for providing an improved fire sprinkler. Specifically, a solenoid valve is provided that couples to a pipe system of the fire sprinkler system. The solenoid valve is operably associated with at least one of a heat detector such that the solenoid valve opens and water is permitted to flow through the solenoid valve and pipe system when a signal is received from the at least one of a heat detector and a smoke detector. Advantageously, a solenoid driven system eliminates accidental system trips and freeze ups, like the problematic ones described above. Embodiments of the present invention also eliminate the use of accelerators and actuators, which are prone to failure and result in false fire alarms (and in some cases, even property damage).

The present invention, in comparison to an anti-freeze system, is more eco-friendly, with less required maintenance and mess, which also makes it more economical. The solenoid driven system disclosed herein improves dependability and cost efficiency with less service and repairs. Jurisdictions require the use of compressed air or nitrogen to maintain system integrity. However, with the present invention, a total loss of air would not cause the system to trip (i.e., water would not be allowed into the sprinklers) and, rather, it would send a trouble signal to make people aware of potential damage. Further, with such a system that requires low compressed air be forced out prior to water reaching the fire, water delivery speeds can be increased in comparison to the prior art. Water delivery in a fire would be fast with low air pressure or nitrogen. A system in accordance with the present invention will only activate with the activation of a heat or smoke detector, utilizing 24 volts direct current (v DC).

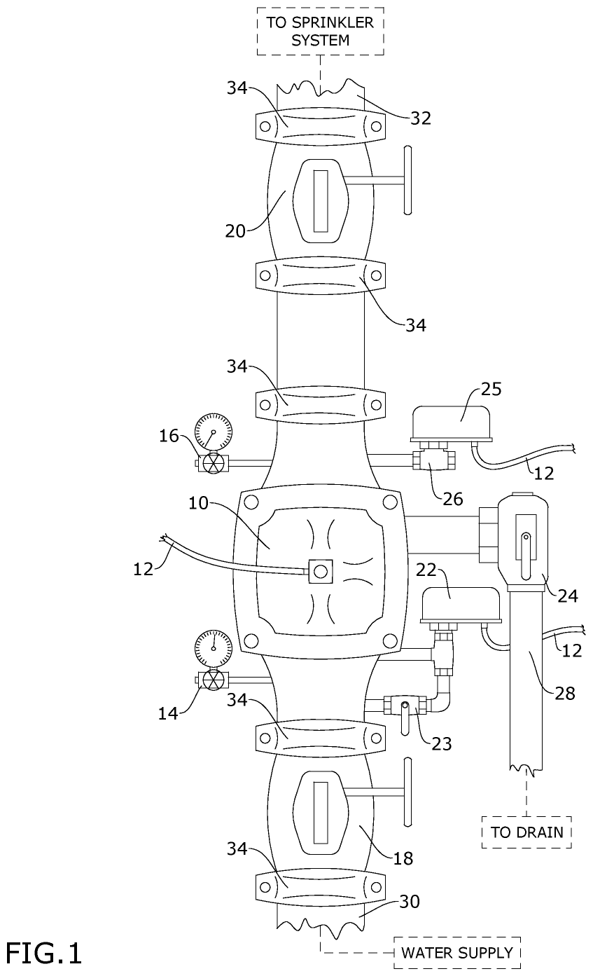

Referring to FIG. 1, a solenoid fire sprinkler apparatus is provided as a vertically stacked riser along a pipe system, which comprises a water supply pipe 30 and a system supply pipe 32. Pipe sections may be joined, for example, using a groove coupling 34. The apparatus, as shown in the embodiment of FIG. 1, includes a solenoid valve 10 which is powered for selective actuation by a 24v DC power source via an electrical connection 12. The solenoid valve is provided with two pressure gauges 14, 16. A supply side pressure gauge 14 provides a pressure reading within the pipe system on the water supply side of the solenoid valve 10. A system side pressure gauge 16 provides a pressure reading within the pipe system on the water delivery side of the solenoid valve 10.

A main isolation control valve 18 isolates the water supply for service to be performed, as needed. The main isolation control valve may be equipped with an internal tamper switch that is monitored by an alarm company and alerted if a valve were to be shut (i.e., water is prevented from travelling through the pipes to the sprinkler system). There is further provided a secondary control valve 20 with a tamper, which may be selectively closed for testing of the solenoid valve 10 and the pressure switch 22. The secondary control valve 20 prevents water from entering the system unnecessarily during testing.

Making further reference to FIGS. 1-3, a low air pressure switch 25 powered via an electrical connection 12, is provided along the pipe system on the system side for detection of low air pressure. When the low air pressure switch 25 detects low air pressure due to damage or activation of a sprinkler head due to heat, a supervisor signal will be sent to the panel. As shown in FIG. 1, an alarm test valve 23 is provided along the pipe system on the supply side. A water pressure flow switch 22, powered via an electrical connection 12, is provided along the pipe system on the supply side for detection of the flow of water. When the water pressure flow switch 22 detects water flow, a fire alarm is activated which also alerts a fire department and/or alarm company for response. A test and drain valve 24 is coupled to the pipe system, proximal the solenoid valve, and connects with a drain pipe 28. The test and drain valve 24 is a two position valve that opens to a one-half inch orifice to simulate water flow through a sprinkler head and test the flow switch for required inspections. A test, inspection, and air supply ball valve 26, which may be embodied as a one-half inch ball valve, is used for hydrostatic testing, inspection, and air supply. Fire sprinkler systems in accordance with the present invention should be routinely tested and inspected annually at minimum, as required by the National Fire Protection Association (NFPA™)

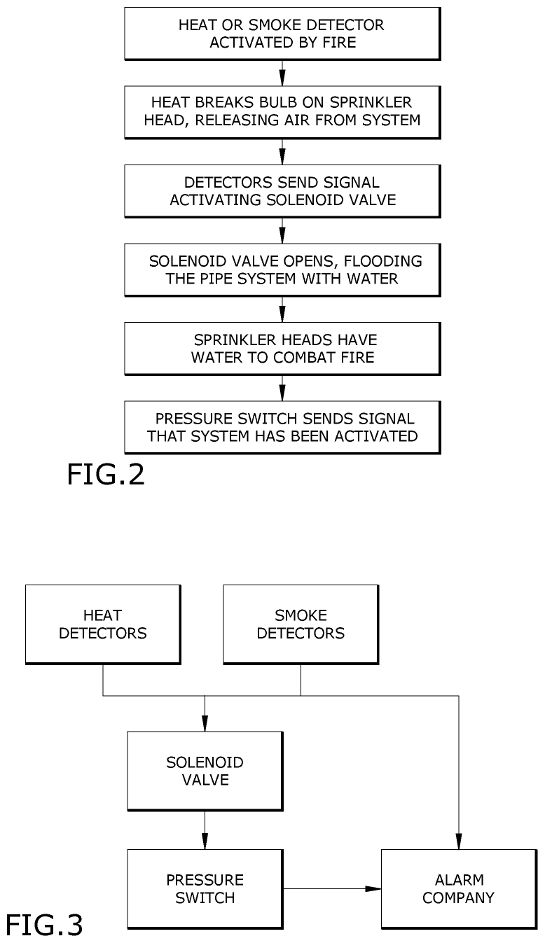

FIGS. 2 and 3 illustrate an exemplary process of using the embodiment of the present invention. When the solenoid valve system is in service, both control valves 18, 20 are open, with the solenoid valve 10 closed which holds back the water in the water supply pipe 30. In this state, all low-voltage 24v DC fire alarm functions/elements (e.g., the solenoid valve 10 and pressure switch 22) are wired and monitored by an alarm company. During a fire event, heat and/or smoke detectors are activated and send a signal to automatically activate the solenoid valve electronically to open and flood the system supply pipe 32 with water. One or more bulbs on sprinkler heads in the sprinkler system will break due to the heat of the fire, and water is delivered quickly to the open sprinkler (this step may also occur prior to the solenoid being activated). As the flow of water is detected by the water pressure flow switch 22, and in conjunction with the heat and smoke detectors, a signal/alert is sent to an alarm company and/or the fire department to respond to the fire event.

While methods of making the present invention would be readily apparent to those with skill in the art from the foregoing disclosure, an exemplary method may include the following. A custom solenoid valve 10 may be fabricated using a custom solenoid manufacturer such that the solenoid may be appropriately integrated with a fire sprinkler system as illustrated and described herein. Once fabricated, the solenoid valve 10 is assembled with the fire sprinkler system, with all appropriate electrical connections being made to ensure the system functions as described above.

The system described herein may be used in places subject to freezing temperatures, including, but not limited to, food distribution warehouse freezers, multi-family structures and hotels with attics, canopies, porte cocheres and multi-level parking structures. In other buildings, this system may be used in water sensitive areas, like data rooms and server rooms. In general, it may be used in any residential, commercial, or industrial building. Some hazards would require a deluge system, where all the sprinklers are open as installed. The solenoid valve 10 of the present invention can be used as part of various types of fire sprinkler systems, including dry systems, pre-action systems, and deluge systems. The solenoid driven valve 10 simplifies the current dry and pre-action fire sprinkler valves currently in use. It eliminates additional components that are currently used for dry, pre-action and deluge fire sprinkler systems, reducing operation costs, and increasing the reliability of the system.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

The terms “proximal” and “distal” are defined herein relative to the solenoid valve. The term “proximal” refers to the position of an element closer to the solenoid valve and the term “distal” refers to the position of an element further away from the solenoid. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A fire sprinkler system comprising:
a pipe system;
at least one of a heat detector and a smoke detector; and
a solenoid valve coupled along the pipe system and operably associated with the at least one of a heat detector and the smoke detector, the solenoid valve being operable to permit water to flow therethrough upon receiving a signal from the at least one of a heat detector and a smoke detector.

2. The fire sprinkler system of claim 1, further comprising a water pressure flow switch configured to detect the flow of water through the solenoid valve.

3. The fire sprinkler system of claim 2, further comprising a fire alarm, the water pressure flow switch being configured to activate the fire alarm upon detection of the flow of water through the solenoid valve.

4. The fire sprinkler system of claim 2, wherein the water pressure flow switch is configured to send a signal to at least one of a fire department and an alarm company upon detection of the flow of water through the solenoid valve.

5. The fire sprinkler system of claim 1, wherein the pipe system comprises a water supply pipe and a system supply pipe, with the solenoid valve being coupled therebetween.

6. The fire sprinkler system of claim 5, further comprising a water supply side pressure gauge for providing a pressure reading within the water supply pipe and system side pressure gauge for providing a pressure reading within the system supply pipe.

7. The fire sprinkler system of claim 5, further comprising a main isolation control valve coupled to the water supply pipe and a secondary control valve coupled to the system supply pipe.

8. The fire sprinkler system of claim 1, wherein the solenoid valve is selectively powered by 24 volts direct current.

9. An apparatus configured for use with a fire sprinkler system, the apparatus comprising:
a solenoid valve being configured:
to couple along a pipe system of the fire sprinkler system; and
to be operably associated with at least one of a heat detector and a smoke detector, the solenoid valve being operable to permit water to flow therethrough upon receiving a signal from the at least one of a heat detector and a smoke detector.

10. A method comprising:
providing a fire sprinkler system comprising:
a pipe system;
at least one of a heat detector and a smoke detector; and
a solenoid valve coupled along the pipe system and operably associated with the at least one of a heat detector and the smoke detector;
receiving a signal from the at least one of a heat detector and a smoke detector; and
operating the solenoid valve to permit water to flow therethrough.
